(19) United States
(12) Patent Application Publication
(10) Pub. No.: US 2013/0346236 A1
(43) Pub. Date: Dec. 26, 2013

(54) SYSTEM AND METHOD FOR PROVIDING A MULTIMEDIA MARKETPLACE

(71) Applicants: Derrick Charles Fung, Toronto (CA); Brandon Michael Karvin Chu, Toronto (CA)

(72) Inventors: Derrick Charles Fung, Toronto (CA); Brandon Michael Karvin Chu, Toronto (CA)

(21) Appl. No.: 13/533,447

(22) Filed: Jun. 26, 2012

(51) Int. Cl. G06Q 20/22; G06Q 30/00

(52) U.S. Cl. CPC G06Q 20/29; G06Q 30/00
USPC 705/26.8

(57) ABSTRACT

A system and method for providing a multimedia marketplace amongst consumer devices, artist devices and service provider devices. A consumer account including a credit account is stored for each consumer registration request received from consumer devices. An artist account including an artist credit account is stored for each artist registration request from artist devices. A service provider registration request including an offer to sell a product is received from a service provider device. When a play of the media composition is detected at a consumer device, credit is deposited into the consumer's credit account. When a donation request associated with that consumer account is received, credit is donated from the consumer's credit account to an artist credit account. A purchase request associated with an artist account is received from an artist device, the purchase request requesting to spend credit from the artist credit account to purchase the product.

### FIELD

Embodiments described herein generally relate to communications and computing devices, and more specifically to a system and a method for providing a multimedia marketplace.

### INTRODUCTION

In a traditional artist publishing model, an aspiring artist may record and submit a demo tape to a record label for consideration. The record label may offer to finance one or more albums by the artist, if the demo tape sounds promising. Specifically, the record label may offer to fund and manage, for example, studio recording, audio production, packaging, distribution, marketing and revenue collection.

Under this artist publishing model, a record label bears considerable risk. The artist may not have had any public exposure nor have any real fan base to evidence their public appeal and marketability. Therefore, to minimize risk, record labels may offer financing to only a small proportion of aspiring artists. This can create a barrier to aspiring artists whom record labels consider to be a risky investment.

As stated above, a record label may take on considerable risk by financing an aspiring artist. For this reason, the record label may demand most of the profits generated by that artist in exchange for the financing. Accordingly, even the most successful artists may find that their efforts generate relatively little return for themselves.

Accordingly, there exists a need for a new artist publishing model which may permit an artist to take more control over their career. However, a new artist publishing model may require a new multimedia marketplace in which consumers, artists and service providers can interact. Accordingly, there also exists a need for new systems for providing such a marketplace.

### SUMMARY

The embodiments described herein provide in one aspect, a system for providing a multimedia marketplace amongst a plurality of consumer devices, artist devices and service provider devices. The system comprising a server device including a memory, a storage device, computer readable instructions stored in the memory, and a processor configured to execute the computer readable instructions, wherein the server device is configured to receive a plurality of consumer registration requests, one from each consumer device; store a plurality of consumer accounts in the storage device, one consumer account for each consumer registration request, each consumer account including a credit account; receive a first artist registration request from one of the artist devices, the first artist registration request including a reference to a media composition; store a first artist account in the storage device, the first artist account including a first artist credit account; receive a service provider registration request from one of the service provider devices, the service provider registration request including an offer to sell a product; detect a play, at a consumer device, of the media composition, wherein the play is associated with a consumer account; in response to the detection of a play, deposit credit, at the storage device, into the credit account of that consumer account; receive a donation request, associated with that consumer account, the donation request requesting to donate credit from the credit account of that consumer account to the first artist credit account; and receive a purchase request, associated with the first artist account, from one of the first artist devices, the purchase request requesting to spend credit from the first artist credit account to purchase the product.

The embodiments described herein provide in another aspect, a method for providing a multimedia marketplace amongst a plurality of consumer devices, artist devices and service provider devices. The method comprising receiving a plurality of consumer registration requests, one from each consumer device; storing a plurality of consumer accounts in the storage device, one consumer account for each consumer registration request, each consumer account including a credit account; receiving a first artist registration request from one of the artist devices, the first artist registration request including a reference to a media composition; storing a first artist account in the storage device, the first artist account including a first artist credit account; receiving a service provider registration request from one of the service provider devices, the service provider registration request including an offer to sell a product or service; detecting a play, at a consumer device, of the media composition, wherein the play is associated with a consumer account; in response to the detection of a play, depositing credit, at the storage device, into the credit account of that consumer account; receiving a donation request, associated with that consumer account, the donation request requesting to donate credit from the credit account of that consumer account to the first artist credit account; and receiving a purchase request, associated with the first artist account, from one of the first artist devices, the purchase request requesting to spend credit from the first artist credit account to purchase the product.

The embodiments described herein provide in another aspect, a system for providing a multimedia marketplace amongst a plurality of consumer devices, artist devices and service provider devices, the system comprising a server device including a memory, a storage device, computer readable instructions stored in the memory, and a processor configured to execute the computer readable instructions, wherein the server device is configured to receive a plurality of consumer registration requests, one from each consumer device; store a plurality of consumer accounts in the storage device, one consumer account for each consumer registration request, each consumer account including a credit account; receive a plurality of artist registration requests, one from each artist device, each artist registration request including a reference to a media composition; store a plurality of artist accounts in the storage device, each artist account including a credit account; determine a sum of money received in return for deposits of credit into credit accounts of consumer accounts; determine a sum of credit in the credit accounts of the plurality of artist accounts; and determine a fraction of the sum of money to allocate to each artist account based upon an amount of credit in the artist credit account and the sum of credit.

The embodiments described herein provide in another aspect, a method for providing a multimedia marketplace amongst a plurality of consumer devices, artist devices and service provider devices. The method comprising receiving a plurality of consumer registration requests, one from each consumer device; storing a plurality of consumer accounts in the storage device, one consumer account for each consumer registration request, each consumer account including a credit account; receiving a plurality of artist registration requests, one from each artist device, each artist registration request including a reference to a media composition; storing a plurality of artist accounts in the storage device, each artist account including a credit account; determining a sum of money received in return for deposits of credit into credit accounts of consumer accounts; determining a sum of credit in the credit accounts of the plurality of artist accounts; and determining a fraction of the sum of money to allocate to each artist account based upon an amount of credit in the artist credit account and the sum of credit.

Further aspects and advantages of the embodiments described herein will appear from the following description taken together with the accompanying drawings.

### DRAWINGS

For a better understanding of the described embodiments and to show more clearly how they may be carried into effect, reference will now be made, by way of example, to the accompanying drawings in which:

FIG. 1 shows a block diagram illustrating a system for providing a multimedia marketplace, in accordance with at least one embodiment;

FIG. 2 shows a block diagram of a device that illustrates hardware components usable by one or more elements of the system of FIG. 1;

FIG. 3 shows a block diagram which illustrates a method of registering consumers, artists and service providers in a multimedia marketplace, in accordance with at least one embodiment;

FIG. 4 shows a block diagram of a method that illustrates exemplary sources and sinks of credits in a multimedia marketplace, in accordance with at least one embodiment;

FIG. 5 shows an example of a user interface displayable by a consumer device, in accordance with at least one embodiment;

FIG. 6 shows an example of a user interface displayable by a consumer device, in accordance with at least one embodiment;

FIG. 7 shows an example of a user interface displayable by a consumer device, in accordance with at least one embodiment;

FIG. 8 shows an example of a user interface displayable by a consumer device, in accordance with at least one embodiment; and

FIG. 9 shows an example of a user interface displayable by an artist device, in accordance with at least one embodiment.

### DESCRIPTION OF VARIOUS EMBODIMENTS

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

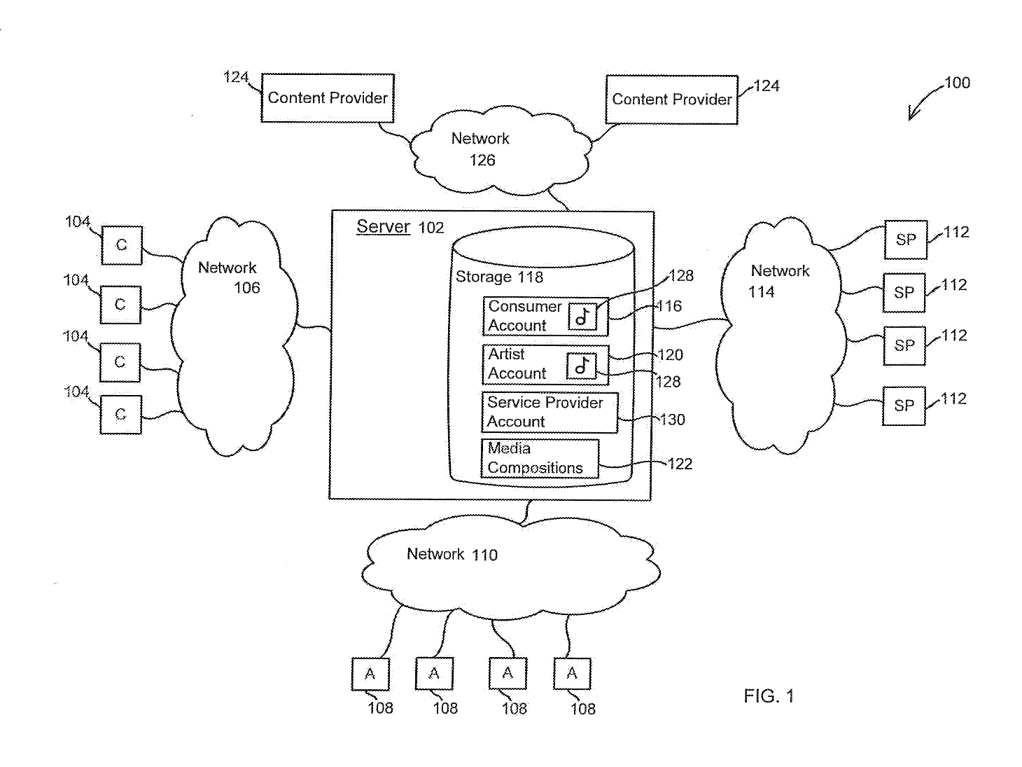

FIG. 1 shows a block diagram illustrating a system 100 for providing a multimedia marketplace. The multimedia marketplace may support a new artist publishing model. In the new artist publishing model, consumers can show their support for aspiring artists and those artists can leverage that support to connect with service providers (e.g. recording studios, advertisers, or audio producers etc.).

Service providers may offer promotional products to artists who have a demonstrated fan base of consumers. The term “product” as it relates to service providers, and as offered by service providers to artists, will be understood to include various service offerings typical in the recording industry such as studio recording time, an advertisement campaign or audio production at a discount price in money. The existing fan base may evidence the marketability and public appeal of that artist. Therefore, an artist with an existing fan base may be considered a lesser investment risk to a service provider.

In the same vein, an artist with a strong existing fan base has a better chance of future success. A service provider who assists with an artist's rise to frame may share in the artist's success. Accordingly, a new service provider may wish to work with “the next big artist” to showcase the service provider's services and to bolster the service provider's reputation by association.

System 100 comprises a server device 102 which communicates with a plurality of consumer devices 104 via a network 106, with a plurality of artist devices 108 via a network 110, and with a plurality of service provider devices 112 via a network 114. In some cases, two or more of networks 106, 110 and 114 may comprise mutual nodes (e.g. the Internet).

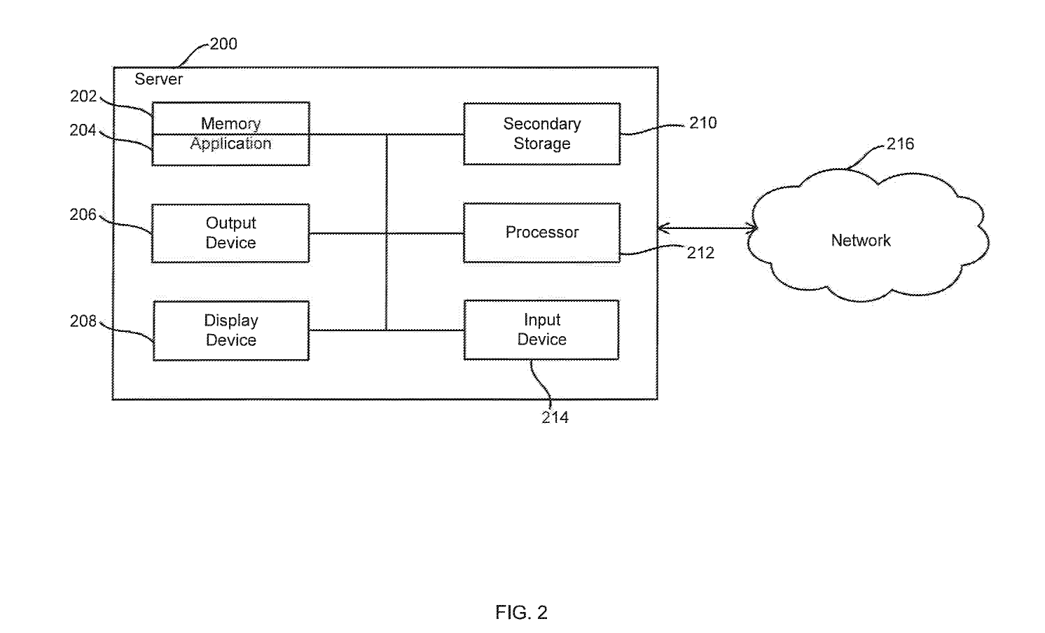

FIG. 2 shows an example of a device 200. Device 200 generally illustrates hardware components that may be used by one or more of the elements of system 100, such as server device 102, consumer devices 104, artist devices 108, and service provider devices 112. Generally, a device 200 may be a server computer, desktop computer, notebook computer, tablet, FDA, smartphone, or another computing device. Device 200 may include a connection with a network 216 such as a wired or wireless connection to the Internet. In some cases, network 216 may include other types of computer or telecommunication networks. Network 216 may correspond with networks 106, 110 and 114 shown in FIG. 1. Device 200 may include one or more of a memory 202, a secondary storage device 210, a processor 212, an input device 214, a display device 208, and an output device 206.

Memory 202 may include random access memory (RAM) or similar types of memory. Also, memory 202 may store one or more applications 204 for execution by processor 212. Applications 204 may correspond with software modules comprising computer executable instructions to perform processing for the functions described below. Secondary storage device 210 may include a hard disk drive, floppy disk drive, CD drive, DVD drive, Blu-ray drive, or other types of non-volatile data storage. Processor 212 may execute applications, computer readable instructions or programs. The applications, computer readable instructions or programs may be stored in memory 202 or in secondary storage 210, or may be received from the Internet or other network 216. Input device 214 may include any device for entering information into device 200. For example, input device 214 may be a keyboard, key pad, cursor-control device, touch-screen, camera, or microphone. Display device 208 may include any type of device for presenting visual information. For example, display device 208 may be a computer monitor, a flat-screen display, a projector or a display panel. Output device 206 may include any type of device for presenting a hard copy of information, such as a printer for example. Output device 206 may also include other types of output devices such as speakers, for example. In some cases, device 200 may include multiple of any one or more of processors, applications, software modules, second storage devices, network connections, input devices, output devices, and display devices.

Although device 200 is depicted with various components, one skilled in the art will appreciate that this device may in some cases contain fewer, additional or different components. In addition, although aspects of an implementation of device 200 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling device 200 and/or processor 212 to perform a particular method.

In the description that follows, devices such as server device 102, consumer device 104, artist device 108 and service provider device 112 are described performing certain acts. It will be appreciated that any one or more of these devices may perform an act automatically or in response to an interaction by a user of that device. That is, the user of the device may manipulate one or more input devices (e.g. a touchscreen, a mouse, or a button) causing the device to perform the described act. In many cases, this aspect may not be described below, but it will be understood.

As an example, it is described below that a consumer device 104 may send a registration request to server device 102. Consumer device 104 may send the registration request automatically, or in response to an interaction by a consumer. For example, a consumer using the consumer device 104 may manipulate one or more input devices (e.g. a mouse and a keyboard) to interact with a user interface displayed on a display of the consumer device 104 to fill out and submit a registration form. Generally, a device may receive a user interface from a network, such as networks 106, 110 and 114 (e.g. in the form of a webpage). Alternatively or in addition, a user interface may be stored locally at a device (e.g. a cache of a webpage or a mobile application).

Server device 102 may be configured to receive a plurality of registration requests, one from each of the plurality of consumer devices 104, one from each of a plurality of artist devices 108 and one from each of a plurality of service provider devices 112. Generally, the registration requests may comprise at least an identifier identifying the registering consumer, artist or service provider respectively. For example, the registration request may comprise one or more of a username, e-mail address, password, or social media handle.

In response to a consumer registration request, server device 102 may store a consumer account 116 in a storage device 118. In response to an artist registration request, server device 102 may store an artist account 120 in the storage device 118. In response to a service provider registration request, server device 102 may store a service provider account 130 in the storage device 118. Storage device 118 may correspond with secondary storage 210 of device 200 described above with reference to FIG. 2. Generally, storage device 118 may be any suitable storage device such as a hard disk drive, a solid state drive, a memory card, or a disk (e.g. CD, DVD, or Blu-ray etc.). Also, storage device 118 may be locally connected with server device 102. In some cases, storage device 118 may be located remotely from server device 102 and accessible to server device 102 across a network for example. In some cases, storage device 118 may comprise one or more storage devices located at a networked cloud storage provider.

A consumer device 104 may be associated with a consumer account 116. Similarly an artist device 108 may be associated with an artist account 120 and a service provider device 112 may be associated with a service provider account 130. Any suitable mechanism for associating a device with an account is expressly contemplated. In some cases, a device may associate with an account by sending credentials (e.g. a cookie, login, or password etc.) to server device 102. Server device 102 may verify the credentials (e.g. determine that the received password matches a password associated with the account). If a device is associated with an account, server device 102 may consider further acts by that device to be associated with that account.

Similarly, a device 104, 108, 112 may be disassociated with an account 116, 120, 130. Any suitable mechanism for disassociating a device from an account is expressly contemplated. In some cases, a device may send a request to server device 102 requesting to disassociate with an account. For example, a device may send a “logout” request. In some cases, server device 102 may consider a device to be disassociated automatically after a period of inactivity. After a device is disassociated with an account, server device 102 may consider further acts by that device to not be associated with that account (until the device is re-associated as described above).

An artist device 108 may send a request to server device 102 requesting to register a media composition. The request may include a reference to the media composition. Accordingly, server device 102 may be configured to receive the registration request including the reference to the media composition.

Generally, server device 102 may make the media composition available for consumption by consumer devices 104. This may help to expose an artist and his/her media compositions to consumers. Consumers exposed to an artist and his/her media compositions may support the development of that artist. As described in further detail below, consumers may choose to donate to that artist, or purchase products from that artist. The term “product” as it relates to artists, and as offered by artists to consumers, will be understood to include various items that would be of interest to a consumer including a video-call with the artist, an admission to a virtual concert hosted by the artist and a digital music download by the artist.

In some cases, a request that includes a reference to a media composition may comprise the media composition 122 itself (e.g. a video file or an audio file). For example, an artist device 108 may upload a media composition to server device 102, with the request to register the media composition. In some cases, server device 102 may be configured to store media compositions 122 in a memory such as storage device 118.

In some cases, a reference to a media composition may comprise a resource identifier or link to the media composition at a remote device, such as a content provider 124 (e.g. YouTube™). In this way an artist registration request may be, at least in part, validated through reference to such an account on a content provider. Typically, users must be validated in some way prior to being able to obtain an account from a content provider. Media compositions at a content provider 124 may be accessible to server device 102 and to consumer devices 104 via a network 126. In some cases, server device 102 may facilitate the communication to consumer device 104, of media compositions stored at a content provider 124. In one example, server device 102 may host webpages comprising embedded media players with playback controls. A consumer device 104 may send requests, corresponding to those playback controls, to play selected media compositions stored at a remote content provider 124.

In the embodiment illustrated by FIG. 1, communications from content providers 124 to consumer devices 104 may pass through server 102. That is, a media composition streaming from a content provider 124, may be delivered to a consumer device 104 by server device 102. In variant embodiments, content provider 124 may communicate directly with consumer devices 104. That is, content provider 124 may stream a media composition directly to a consumer device 104.

In some cases, server device 102 may facilitate direct communication between content provider 124 and consumer device 104. Server device 102 may provide consumer device 104 with a method of requesting a media composition from content provider 124. For example, server device 102 may send to consumer device 104, computer readable instructions (e.g. in the form of a webpage comprising an embedded media player) for requesting a media composition from content provider 124.

Each consumer account 116 and each artist account 120 may comprise a credit account 128. A credit account 128 may store an amount, of a virtual currency, specific to the respective consumer or artist account 116, 120. The virtual currency will be referred to herein as “credit”. In practice, the virtual currency may be given any name.

Server device 102 may deposit into a consumer account's credit account 128 in response to one or more of a number of different acts. Generally, server device 102 may deposit credit into a consumer account's credit account 128 when an associated consumer device 104 interacts with artists, with media compositions and with other consumer devices 104. In some cases, rewarding consumers (i.e. the “owners” of the consumer accounts 116) with credit for interactions may encourage them to participate in the multimedia marketplace provided by system 100. Consumer participation may assist with the success of the artist publishing model. In some cases, a consumer may pay money in exchange for credit.

Generally, a consumer device 104 may send a request to play a media composition. Depending on the configuration of system 100, consumer device 104 may send the request to one or both of server device 102 and content provider(s) 124. In some cases, the consumer device 104 may be configured to emit sound from a sound emitting device (e.g. speakers) upon playing the media composition. Server device 102 may be configured to detect the play of the media composition at the consumer device 104, and in response deposit credit into the associated consumer account 116. Thus the more media compositions that a consumer consumes (i.e. plays) with their consumer device 104, the more credits they may earn. This may encourage consumers continue to play media compositions which may assist with the success of the multimedia marketplace.

In some cases, rewarding consumers with credits for playing media content may create an incentive for some consumers to abuse the system in order to gain additional credits. For example, some consumers may attempt to play many media compositions simultaneously or they may attempt to rapidly play short segments of many media compositions consecutively. Accordingly, server device 102 may be configured with mechanisms (e.g. logic in the form of computer readable instructions stored in a memory of server device 102) to prevent abuse. The abuse prevention mechanisms may be calibrated to capture those behaviors which are uncharacteristic even for a dedicated marketplace consumer. Example of abuse prevention mechanisms include, requiring a minimum play time, depositing credits in proportion to the play time of a media composition, prohibiting simultaneous playing of media compositions and setting a maximum number of credits that can be earned by a consumer account's credit account 128 for playing media compositions per period of time (e.g. daily, weekly, or monthly).

A consumer device 104 associated with a consumer account 116 may send to server device 102 a comment in respect of an artists, a media composition or both. In response to receiving the comment, the server device 102 may deposit credit into the consumer account's credit account 128.

Server device 102 may be configured to receive one or more of a number of forms of comments from consumer devices 104. A comment may take the form of a text-based message (e.g. posted to a message board), a categorized rating (e.g. evaluating a media composition or an artist), or an emotion (e.g. visually represented by an emoticon), for example.

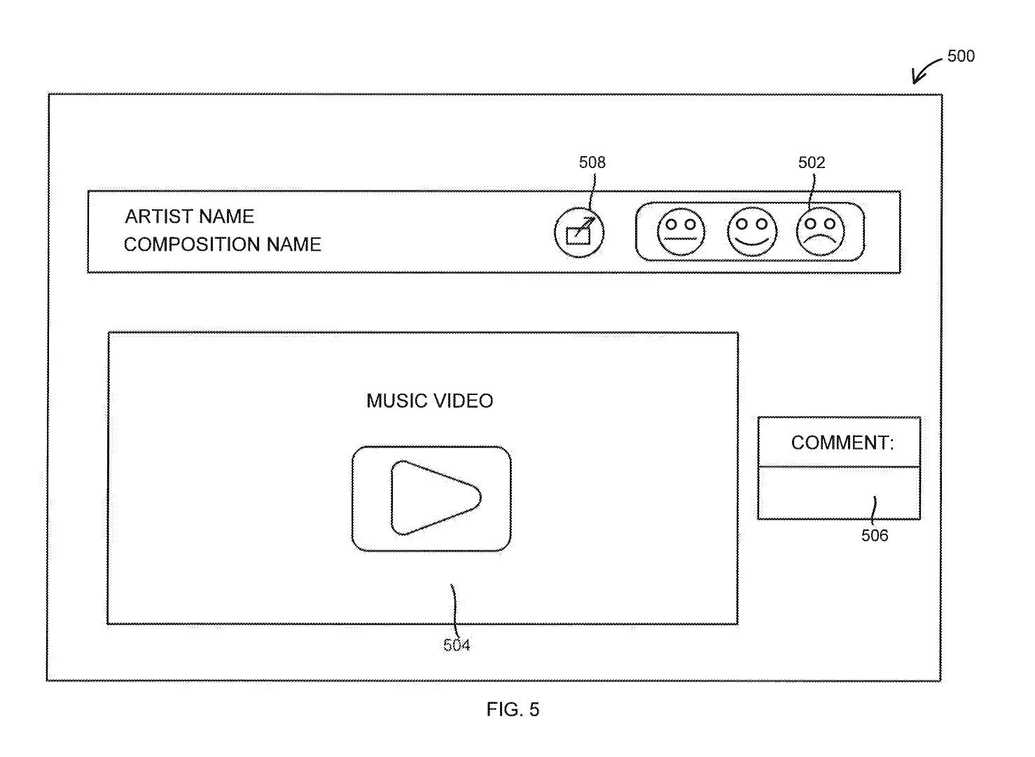

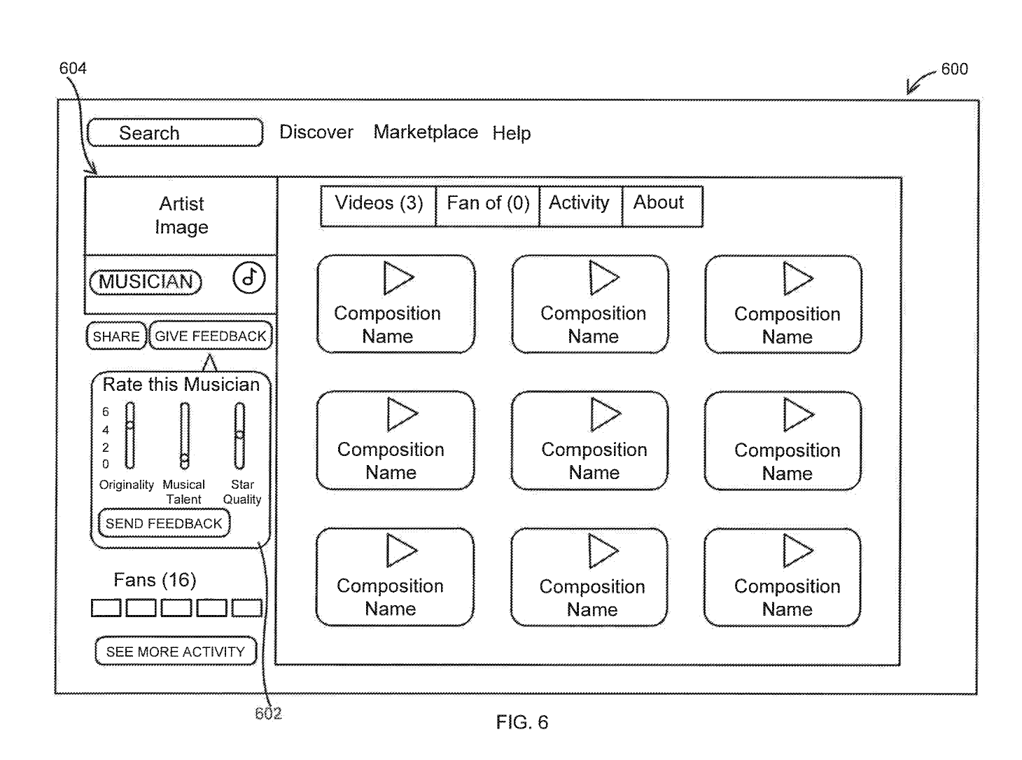

In some cases, a consumer may interact with a user interface displayed on a display of a consumer device 104 to cause consumer device 104 to send a comment to server device 102. FIG. 5 shows an example of a user interface 500 that may be displayed on a display of a consumer device 104. User interface 500 comprises emoticons 502 which are selectable to send an emotion-type comment to server device 102 in respect of the displayed music video 504. User interface 500 also comprises a dialogue box 506 into which text may be inserted for sending a text-based message to server device 102 in respect of music video 504. FIG. 6 shows an example of another user interface 600 that may be displayed on a display of a consumer device 104. User interface 600 comprises rating sliders 602 displayed in association with an artist's profile 604. The rating sliders may be manipulated to send a categorized rating to server device 102 in respect of the artist whose profile 604 is displayed.

Server device 102 may be configured to receive a request, from a consumer device 104 associated with a consumer account 116, to “share” a media composition with a recipient. This may encourage consumers to share media compositions with others (e.g. their friends). This may help to increase the number of consumers in the multimedia marketplace and the level of participation by consumers in the multimedia marketplace, both of which may contribute to the success of the multimedia marketplace.

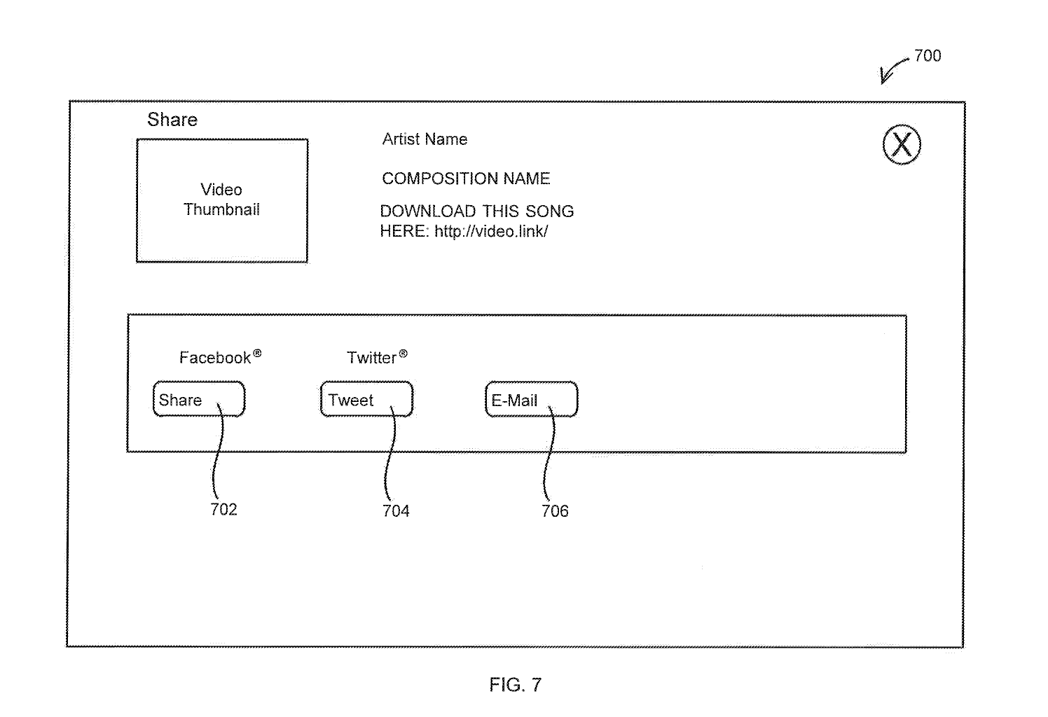

Generally, a consumer device 104 may send a request to “share” a media composition with a recipient. A recipient may be an e-mail address or a social media account, for example. In some cases, a recipient may be associated with a consumer account 116. The example user interface 500, shown in FIG. 5, comprises a button 508 for “sharing” music video 504. In this example, selecting button 508 may cause the display of a sharing user interface, such as user interface 700 shown in FIG. 7. As shown, user interface 700 comprises buttons 702, 704 and 706. Button 702 may be selectable to share a link to music video 504 using a Facebook® social media account; button 704 may be selectable to share a link to music video 506 using a Twitter® social media account; and button 706 may be selectable to share a link to music video 506 with an email recipient.

Generally, consumers may spend credits by donating credits to artists, by purchasing products offered by artists or by purchasing system products. In one aspect, a consumer device 104 may send a request to server device 102 requesting to donate credit from a consumer account's credit account 128 to an artist account's credit account 128. In response to the request, the server device 102 may transfer credits as requested. As discussed in further detail below, an artist may spend credits on products from service providers and may redeem credits for money. Therefore, a consumer's donation to an artist may support that artist in a real way.

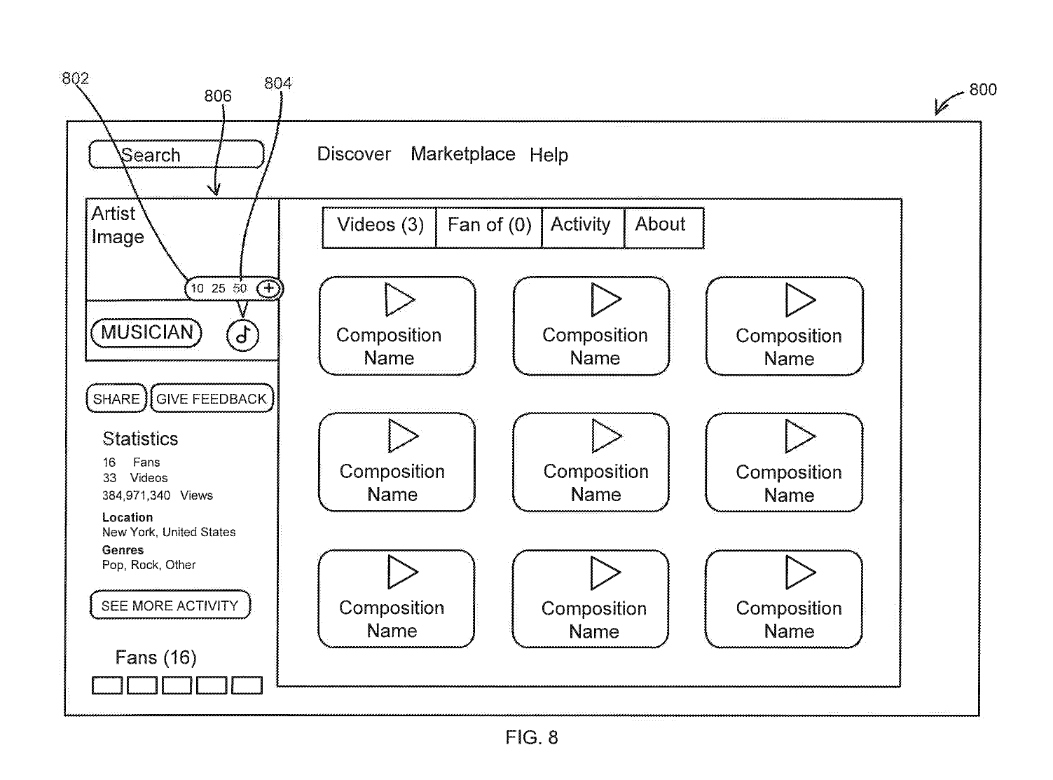

FIG. 8 shows an example of another user interface 800 that may be displayed on a display of a consumer device 104. User interface 800 includes a display panel 802 comprising selectable amounts 804. Amounts 804 may be selectable to cause consumer device 104 to send a request to server device 102 requesting to donate the selected number of credits to the credit account 128 of the artist whose profile 806 is shown.

In some cases, an artist device 108, that is associated with an artist account 120, may send a request to server device 102 requesting to register an offer to sell a product. Examples of product offers may include a video-call with the artist, an admission to a virtual concert hosted by the artist and a digital music download by the artist. The registration request may comprise a price for the product and a quantity limit, for example.

A consumer device 104 associated with a consumer account 116 may send a request to server device 102 requesting to purchase a product offered by an artist. Server device 102 may be configured to receive the request, and in response transfer the purchase price in credits from the consumer account's credit account 128 to the artist account's credit account 128.

In some cases, server device 102 may be configured to set product prices. Product prices may be dependent on factors including the scalability of the product. For example, a product requiring more of the musician's involvement (e.g. a video-call with the artist) may necessitate a higher price (i.e. a greater number of credits). A product requiring less of a musician's involvement (e.g. a virtual concert) may necessitate a lower price (i.e. a fewer number of credits). Purchasable products may motivate consumers to participate in the multimedia marketplace (e.g. by playing media compositions, by sharing media compositions and by commenting) to earn credits to spend. An active community of consumers may contribute to the success of the multimedia marketplace provided by system 100.

In some cases, server device 102 may make “system products” available to consumers for purchase. A system product is a product that is offered by the system and which is not associated with any specific artist or a service provider. Examples of system products include virtual badges (e.g. “I'm a super fan” badge), promotional merchandise (e.g. a t-shirt or a hat), and avatars (i.e. an image that represents a consumer account 116). Server device 102 may be configured to receive a request, from a consumer device 104, requesting to purchase a system product. In response, server device 102 may withdraw the purchase price in credits from the credit account 128 of the consumer account 116 associated with that consumer device 104.

In some cases, a service provider device 112, that is associated with a service provider account 130, may send a request to server device 102 requesting to register an offer to sell a product. Examples of products may include studio recording time, an advertisement campaign or audio production at a discount price in money. The registration request may comprise a price for the product and a quantity limit, for example.

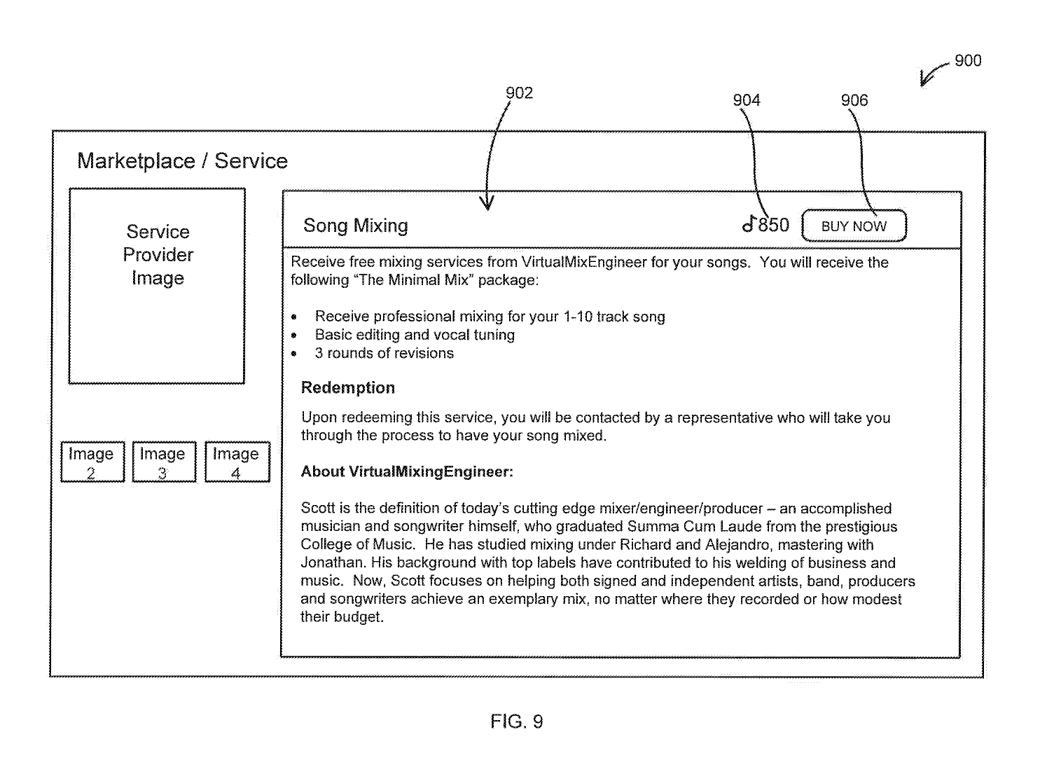

Products offered by service providers may be purchasable by artists. An artist device 108 may send a request to server device 102 requesting to purchase a product offered by a service provider. Server device 102 may be configured to receive the request and in response withdraw the purchase price in credits, from the artist account's credit account 128. FIG. 9 shows an example user interface 900 for purchasing a product offered by a service provider. User interface 900 may be displayed in a display of an artist device 108. In the example shown, user interface 900 comprises a product description 902, a price 904 in credits, and a button 906. Button 906 may be selectable to cause artist device 108 to send a purchase request to server device 102.

In some cases, a service provider account 130 may not comprise a credit account. When an artist purchases a product, a service provider may not receive the purchase price in credit. Instead, a service provider may be satisfied by the potential benefits of working with an artist who purchases the service provider's product. For example, the reputation of a service provider may benefit from an association with a rising artist.

In some cases, system 100 may permit a service provider to limit which artists may purchase that service provider's products. System 100 may be configured to exclude artists from purchasing a service provider's product based upon one or more of an artist's credit balance at the time of purchase and a number of credits received by an artist over a past period (e.g. last month, last 12 months, or lifetime). As discussed above, an artist may generally receive credit in response to the acts of their consumer fans (e.g. donations, product purchases and plays of media compositions). Therefore, an artist's credits, past and present, may reflect the strength of an artist's fan base of consumers. Accordingly, system 100 may limit the purchase of service provider products to artists with a certain fan base of consumers using an artist's past credit earnings and present credit balance. This may permit a service provider to realize the benefit they seek from the sale of their product (e.g. an association with a rising star).

A service provider device 112 may send a request to server device 102 requesting to register an offer to sell a product. Server device 102 may be configured to receive the request, and in response, make the product available for purchase by artists. Generally, an offer to sell a product, from a service provider device 112, may comprise a price. An artist may not purchase a product unless they have as many credits in their credit account 128 as the price of the product. Accordingly, server device 102 may be configured to receive a purchase request, from an artist device 108 that is associated with an artist account 120, for a product offered by a service provider, only if the amount of credit in the artist account's credit account 128 is greater than or equal to the purchase price.

In some cases, a service provider device 112 may send to server device 102 a request to register an offer to sell a product, the offer including a fraction for periodically determining a purchase price. Server device 102 may be configured to receive this request, and in response periodically (e.g. daily, weekly, monthly, or yearly) determine a price for the product based upon the fraction provided. The price may be determined such that only this fraction of artists has enough credits to purchase the product. That is, determining the price may comprise determining an amount of credit, wherein only about this fraction of all artists have greater than or equal to that amount of credit in their credit account 128. This may limit the purchase of a product offered by a service provider to the top artists, by credit balance.

In some cases, a service provider device 112 may send a request to server device 102 to register an offer to sell a product, the offer including an amount of credit. Server device 102 may be configured to receive this request, and in response, receive requests to purchase the product only from artists whose credit earnings over a past period (e.g. last month, past 12 months, or lifetime etc.) are greater than or equal to the amount. To this end, server device 102 may determine a sum of credit deposits into an artist account's credit account 128 over a period of time, before determining whether to receive a purchase request, from an artist device 108 associated with that artist account 120. In some cases, the offer from a service provider to sell a product may not comprise a purchase price (or the purchase price may be zero credits). The service provider may be more interested in an artist's past earnings than the artist's current balance (e.g. which may have been diminished by intervening purchases).

In some cases, a service provider device 112 may send a request to server device 102 to register an offer to sell a product, the offer including a fraction for determining top artists by past credit earnings. Server device 102 may be configured to receive the request. In response, server device may be configured to receive requests to purchase the product only from the top fraction of artists, by credit earnings over a past period (e.g. last month, last 12 months, or lifetime etc.). To this end, server device 102 may determine an amount of credit, where only a fraction of artists' credit accounts 128 earned is greater than or equal to this amount over the past period. Server device 102 may determine this amount periodically (e.g. daily, weekly, monthly etc.) or with each request to purchase a product. Server device 102 may determine whether to receive a request to purchase a product from an artist device 108, by determining whether deposits into that artist's credit account 128 over the past period are greater than or equal to the determined amount.

In some cases, artists may be paid money in exchange for their credit. For example, server device 102 may periodically (e.g. daily, weekly, monthly, yearly) allocate to artists accounts 120 a portion of a sum of money received from consumer purchases of credit over the last period.

In some cases, money may be allocated to artist accounts 120 pro-rata by current credit balance. That is, server device 102 may determine the portion to allocate to an artist account 120 based upon a comparison of the amount of credit in that artist account's credit account 128 and the sum total of credit in all artist accounts' credit accounts 128.

In some cases, money may be allocated to artist accounts 120 pro-rata by past earnings over a period (e.g. daily, weekly, month or since the last money allocation). That is server device 102 may determine the portion to allocate to an artist account 120 based upon a comparison of the amount of credit deposited into that artist account's credit account 128 over the period, and the sum total of credit deposited into all artist accounts' credit accounts 128 over the period.

In some cases, only a certain fraction of money received from consumer purchases of credit may be allocated to artist accounts 120. For example, server device 102 may be configured to allocate one half of money received from consumer purchases of credit. Server device may determine a portion of the half to allocate to each artist account 120.

In some cases, after server device 102 allocates money to artist accounts 120, the artist accounts' credit accounts 128 may be reset to zero. If the server device 102 determines the portion to allocate to artist accounts 120 based upon credit balances, then this may provide artists with a choice of either spending their credit on purchases or saving their credits for the periodic payout.

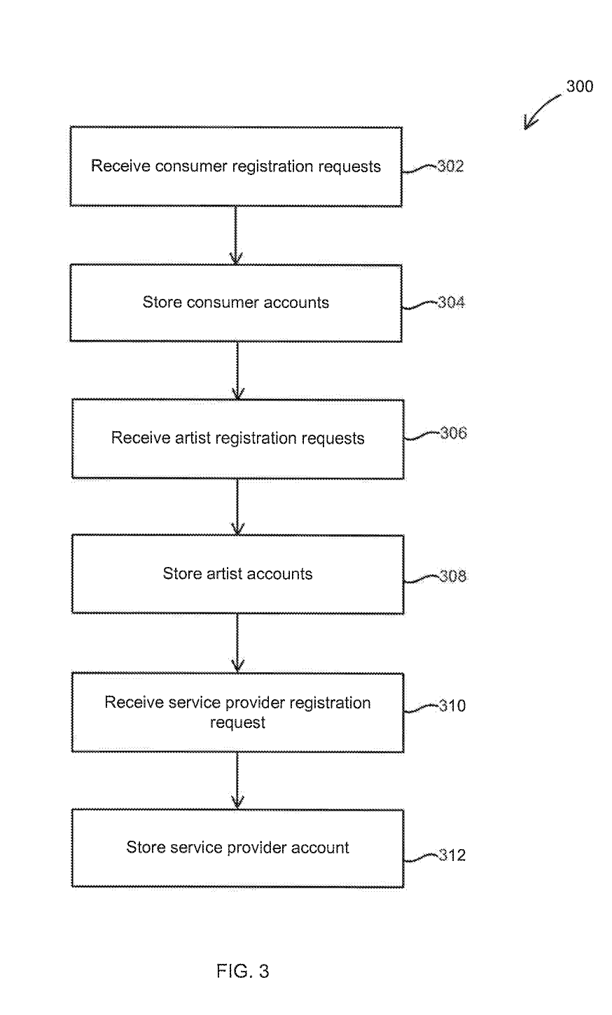

FIG. 3 shows a block diagram which illustrates a method 300 of registering consumers, artists and service providers in a multimedia marketplace. Method 300 is described without limitation. In some cases, some acts of method 300 may occur in a different order from the example shown. In some cases, some acts of method 300 may occur multiple times, and other acts may not occur at all.

At 302, server device 102 receives a plurality of registration requests, one from each of a plurality of consumer devices 104.

In response to each consumer registration request, server device 102 may, at 304, store a consumer account 116 in storage device 118 of server device 102. A consumer account 116 may take the form of a discrete file, as one or more entries in a database, or as an instance of a class, for example. A consumer account 116 may comprise a credit account 128 for storing an amount of credit associated with the consumer account 116. A consumer account 116 may also comprise biographical information (e.g. name, country of residence, or age etc.) and preferences (e.g. favorite artists, or preferred music genres, etc.).

At 306, server device 102 receives a plurality of artist registration requests, one from each of a plurality of artist devices 108. In some cases, an artist registration request may require the artist to provide a reference to an account on a content provider platform and a reference to a media composition by the artist, such as a song or a video. In some cases, an artist registration request may be accompanied by an offer to sell a product. The offer to sell a product may comprise a price in credits.

In response to each artist registration request, server device 102 may, at 308, store an artist account 120 in storage device 118 of server device 102. An artist account 120 may take the form of a discrete file, as one or more entries in a database, or as an instance of a class, for example. An artist account 120 may comprise a credit account 128 for storing an amount of credit associated with the artist account 120. In some cases, an artist account 120 may comprise a reference to a media composition (e.g. authored by the artist submitting the registration request). For example, an artist account 120 may comprise a media composition stored in storage device 118 or a link to a media composition stored at a content provider 124.

At 310, server device 102 may be configured to receive a plurality of service provider registration requests, one from each of a plurality of service provider devices 112. In some cases, a service provider registration request may comprise an offer to sell a product. The offer may comprise a purchase price in credits.

In response to each service provider registration request, server device 102 may, at 312, store a service provider account 130 in storage device 118 of server device 102. In some cases, service provider account 130 may comprise a product for sale.

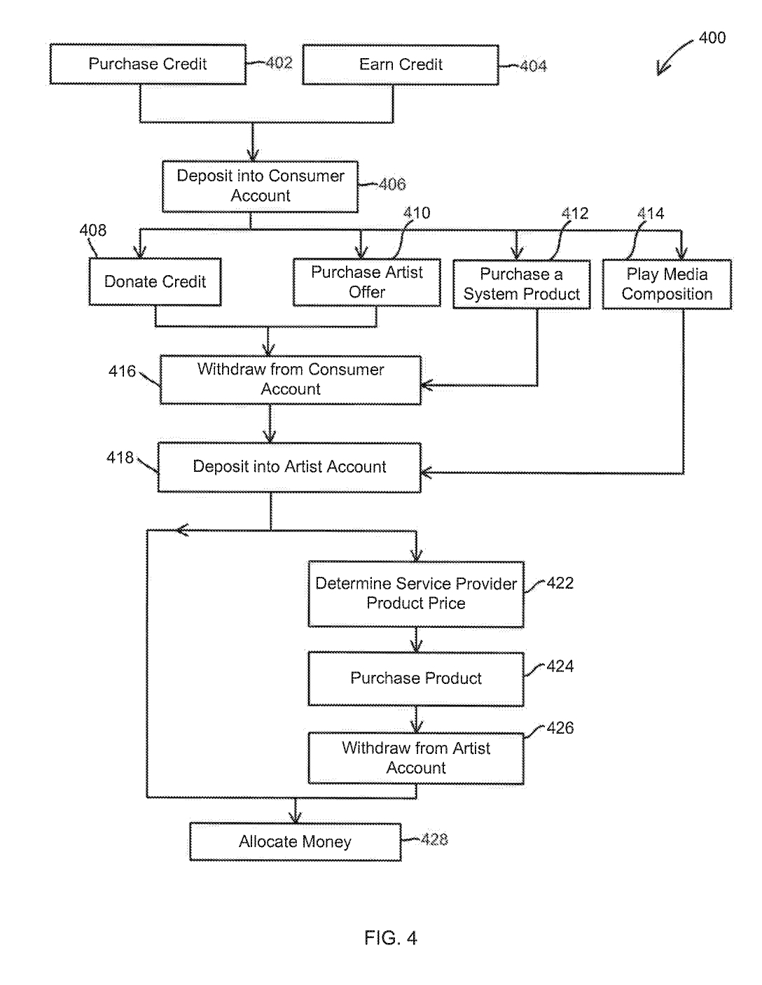

FIG. 4 is a block diagram of a method 400 which illustrates exemplary sources and sinks of credits in a multimedia marketplace. Method 400 is described without limitation. In some cases, some acts of method 400 may be performed in a different order from the example shown. In some cases, some acts of method 400 may be performed multiple times, and some acts may not be performed at all.

Generally, a consumer may gain credit by purchasing credit or earning credit. At 402 a consumer may spend money in exchange for deposits of credit into their consumer account's credit account 128. At 404, a consumer may earn credit by interacting with one or more of artists, artists' media compositions or other consumers for example.

Server device 102 may be configured to, at 406, deposit credits into a consumer's credit account 128 in response to payments of money at 402 and credit earning interactions at 404.

Generally, a consumer may spend credits from their credit account 128 by donating to artists at 408, by purchasing an artist's product at 410, or by purchasing a system product at 412. At 416, server device 102 may withdraw credit from the consumer's credit account 128, in response to a request to donate to an artist, a request to purchase an artist's product or a request to purchase a system product. At 418, server device 102 may deposit credit into an artist's credit account, in response to donations from consumers, or purchases of the artist's products.

At 414, a consumer device 104 may play an artist's media composition (e.g. watch a music video, or listen to an audio stream). In response, server device 102 may, at 418, deposit credit into the artist's credit account 128.

Generally, an artist may spend none, some or all of their credits on products offered by service providers. At 422, server device 102 may determine the price of a product offered by a service provider. As described above, the price may be a fixed amount of credit, or the price may be periodically determined based upon artists' credit balances.

At 424, server device 102 may receive a request from an artist device 108 requesting to purchase a service provider product if the artist's credit account 128 has as many credits as the purchase price, and if the artist's account 120 meets any other exclusionary criterion (e.g. a minimum amount of credit earnings over a past period). In response to the request, server device 102 may withdraw the purchase price in credit from the artist's credit account 128.

At 428, server device 102 may allocate to artist accounts 120 a portion of a sum of money received from consumer purchases of credit. In some cases, the portion allocated to an artist account 120 may be based upon a remaining credit balance in the artist account's credit account 128 at the time of allocation. Variant money allocation mechanisms (e.g. based upon credit earnings instead of credit balances) are contemplated, and some are described in further detail above. In some cases, server 102 may reset artist accounts' credit accounts 128 to zero after allocating money.

A number of embodiments have been described herein. However, it will be understood by persons skilled in the art that other variants and modifications may be made without departing from the scope of the embodiments as defined in the claims appended hereto.

1. A system for providing a multimedia marketplace amongst a plurality of consumer devices, artist devices and service provider devices, the system comprising:
a server device including a memory, a storage device, computer readable instructions stored in the memory, and a processor configured to execute the computer readable instructions,
wherein the server device is configured to:
receive a plurality of consumer registration requests, one from each consumer device;
store a plurality of consumer accounts in the storage device, one consumer account for each consumer registration request, each consumer account including a credit account;
receive a first artist registration request from one of the artist devices, the first artist registration request including a reference to a media composition;
store a first artist account in the storage device, the first artist account including a first artist credit account;
receive a service provider registration request from one of the service provider devices, the service provider registration request including an offer to sell a product;
detect a play, at a consumer device, of the media composition, wherein the play is associated with a consumer account;
in response to the detection of a play, deposit credit, at the storage device, into the credit account of that consumer account;
receive a donation request, associated with that consumer account, the donation request requesting to donate credit from the credit account of that consumer account to the first artist credit account; and
receive a purchase request, associated with the first artist account, from one of the first artist devices, the purchase request requesting to spend credit from the first artist credit account to purchase the product.

2. The system of claim 1,
wherein the offer to sell a product includes a fraction; and
wherein the server device is further configured to:
store a plurality of artist accounts, the plurality of artist accounts including the first artist account, in the storage device, each artist account including a credit account; and
periodically determine a price for the product by determining an amount of credit, wherein all artist accounts, whose credit accounts include greater than or equal to the amount of credit, represent about the fraction of the plurality of artist accounts.

3. The system of claim 1,
wherein the server device is further configured to:
receive a comment from one of the consumer devices, regarding the media composition, where the comment is associated with a consumer account, and in response to receiving the comment, deposit credit, at the storage device, into the credit account of that consumer account.

4. The system of claim 1,
wherein the server device is further configured to:
receive a request, from one of the consumer devices, to share the media composition with a recipient, where the request is associated with a consumer account, and
in response to the request to share, deposit credit, at the storage device, into the credit account of that consumer account.

5. The system of claim 1,
wherein the offer to sell a product includes an amount; and
wherein the server device is further configured to:
receive the purchase request only if a sum of all deposits of credit into the first credit account of the first artist account is greater than or equal to the amount.

6. The system of claim 1,
wherein the offer to sell a product includes a fraction; and
wherein the server device is further configured to:
store a plurality of artist accounts in the storage device, the plurality of artist accounts comprising the first artist account, each artist account including a credit account;
determine, for the credit account of each artist account, a sum of all deposits of credit into that credit account;
determine an amount of credit, wherein all artist accounts, whose determined sum of all deposits of credit is greater than or equal to the amount of credit, represents about the fraction of the plurality of artist accounts; and
receive the purchase request only if said sum for the first credit account of the first artist account is greater than or equal to the amount.

7. The system of claim 1,
wherein the server device is further configured to:
in response to detecting the play, deposit, at the storage device, into the credit account of the first artist account.

8. The system of claim 1,
wherein the server device is further configured to:
receive an offer to sell an artist product, from a first artist device associated with an artist account;
receive a request to purchase the artist product, from a first consumer device associated with a consumer account; and
withdrawing credits from the credit account of that consumer account; and
depositing credits into the credit account of that artist account.

9. The system of claim 1,
wherein the server device is further configured to:
receive a request to purchase a system product, from a first consumer device associated with a consumer account; and
withdraw a purchase price in credit from a credit account of the consumer account.

10. The system of claim 1, wherein that consumer device is configured to emit sound from a sound emitting device upon playing the media composition.

11. A method for providing a multimedia marketplace amongst a plurality of consumer devices, artist devices and service provider devices, the method comprising:
receiving a plurality of consumer registration requests, one from each consumer device;
storing a plurality of consumer accounts in the storage device, one consumer account for each consumer registration request, each consumer account including a credit account;
receiving a first artist registration request from one of the artist devices, the first artist registration request including a reference to a media composition;
storing a first artist account in the storage device, the first artist account including a first artist credit account,
receiving a service provider registration request from one of the service provider devices, the service provider registration request including an offer to sell a product;
detecting a play, at a consumer device, of the media composition, wherein the play is associated with a consumer account;
in response to the detection of a play, depositing credit, at the storage device, into the credit account of that consumer account;
receiving a donation request, associated with that consumer account, the donation request requesting to donate credit from the credit account of that consumer account to the first artist credit account; and
receiving a purchase request, associated with the first artist account, from one of the first artist devices, the purchase request requesting to spend credit from the first artist credit account to purchase the product.

12. A system for providing a multimedia marketplace amongst a plurality of consumer devices, artist devices and service provider devices, the system comprising:
a server device including a memory, a storage device, computer readable instructions stored in the memory, and a processor configured to execute the computer readable instructions,
wherein the server device is configured to:
receive a plurality of consumer registration requests, one from each consumer device;
store a plurality of consumer accounts in the storage device, one consumer account for each consumer registration request, each consumer account including a credit account;
receive a plurality of artist registration requests, one from each artist device, each artist registration request including a reference to a media composition;
store a plurality of artist accounts in the storage device, each artist account including a credit account;
determine a sum of money received in return for deposits of credit into credit accounts of consumer accounts,
determine a sum of credit in the credit accounts of the plurality of artist accounts; and
determine a fraction of the sum of money to allocate to each artist account based upon an amount of credit in the artist credit account and the sum of credit.

13. The system of claim 12, wherein the server device is configured to:
periodically determine the sum of money, the sum of credit and the fraction of the sum of money; and
the money is money received since last determining the sum of money.

14. The system of claim 13, wherein the server device is further configured to:
after determining the fraction, reset the credit accounts of the plurality of artist accounts to zero credits.

15. A method for providing a multimedia marketplace amongst a plurality of consumer devices, artist devices and service provider devices, the method comprising:
receiving a plurality of consumer registration requests, one from each consumer device;
storing a plurality of consumer accounts in the storage device, one consumer account for each consumer registration request, each consumer account including a credit account;
receiving a plurality of artist registration requests, one from each artist device, each artist registration request including a reference to a media composition;
storing a plurality of artist accounts in the storage device, each artist account including a credit account;
determining a sum of money received in return for deposits of credit into credit accounts of consumer accounts,
determining a sum of credit in the credit accounts of the plurality of artist accounts; and
determining a fraction of the sum of money to allocate to each artist account based upon an amount of credit in the artist credit account and the sum of credit.
